(19) United States
(12) Patent Application Publication
(10) Pub. No.: US 2007/0138669 A1
(43) Pub. Date: Jun. 21, 2007

(54) Process for Casting and Extracting Biomedical Devices

(76) Inventors: Yu-Chin Lai, Pittsford, NY (US); Edmond T. Quinn, Rochester, NY (US); Alan C. Wilson, Webster, NY (US)

Correspondence Address: Joseph Barrera;Bausch & Lomb Incorporated, One Bausch & Lomb Place, Rochester, NY, 14604, US

(21) Appl. No.: 11/611,182

(22) Filed: Dec. 15, 2006

Related U.S. Application Data
(60) Provisional application No. 60/752,568, filed on Dec. 21, 2005.

(51) Int. Cl. B29D 11/00

(52) U.S. Cl. 264/1.32; 264/2.6

(57) ABSTRACT

A process for producing polymeric biomedical devices, such as contact lenses, involves casting a monomeric mixture including a diluent; and subsequently removing extractables from the devices by contacting the devices with the an additional volume of the diluent.

This application claims the benefit of Provisional Patent Application No. 60/752,568 filed Dec. 21, 2005 and is incorporated herein by reference.

### FIELD OF THE INVENTION

The present invention relates to a process for casting polymeric biomedical devices, particularly ophthalmic devices including contact lenses, intraocular lenses and ophthalmic implants, and for removing extractables from such devices.

### BACKGROUND OF THE INVENTION

Hydrogels represent a desirable class of materials for the manufacture of various biomedical devices, including contact lenses. A hydrogel is a hydrated cross-linked polymeric system that contains water in an equilibrium state. Hydrogel lenses offer desirable biocompatibility and comfort.

In a typical process for the manufacture of hydrogel polymeric ophthalmic devices, such as contact lenses, a composition containing a mixture of lens-forming monomers is charged to a mold and cured to polymerize the lens-forming monomers and form a shaped article. This monomer mixture may further include a diluent, in which case the diluent remains in the resulting polymeric article. Additionally, some of these lens-forming monomers may not be fully polymerized, and oligomers may be formed from side reactions of the monomers, these unreacted monomers and oligomers remaining in the polymeric article. Such residual materials may affect optical clarity or irritate the eye when the ophthalmic article is worn or implanted, so generally, the articles are extracted to remove the residual materials. Hydrophilic residual materials can be extracted by water or aqueous solutions, whereas hydrophobic residual materials generally involve extraction with an organic solvent. One common organic solvent is isopropanol, a water-miscible organic solvent. Following extraction, the hydrogel lens article is hydrated by soaking in water or an aqueous solution, which may also serve to replace the organic solvent with water. The molded device can be subjected to machining operations such as lathe cutting, buffing, and polishing, as well as packaging and sterilization procedures.

An example of such a process for silicone hydrogel contact lenses is found in U.S. Pat. No. 5,260,000 (Nandu) et al., where silicone hydrogel contact lenses are cast from monomeric mixtures including n-nonanol or n-hexanol as a diluent, and subsequently extracted with isopropanol to remove the diluent as well as unreacted monomers and oligomers.

Although solvents such as isopropanol have proven very effective in extracting undesired residual materials from polymeric biomedical devices, isopropanol is relatively flammable, having a flash point of 11° C.; additionally, it is relatively expensive to dispose of isopropanol. Further, if all isopropanol is not removed or rinsed from the device, the eye irritation may result.

The present invention provides a process that employs extractants that are less flammable, and therefore, safer for manufacturing processes, and easier to dispose of, than conventional solvents such as isopropanol.

### SUMMARY OF THE INVENTION

This invention provides an improved process for producing biomedical devices, particularly ophthalmic biomedical devices, and removing extractables from the devices.

According to one embodiment, this invention relates to a process for producing polymeric biomedical devices, comprising: casting a monomeric mixture comprising a diluent; and subsequently removing extractables from the devices by contacting the devices with said diluent.

According to various preferred embodiments, the diluent has a flash point greater than 40° C., a vapor pressure lower than 10 mmHg at 25° C., and/or a boiling point of at least 100° C. at 1 atm.

Preferably, the devices are ophthalmic biomedical device, especially ophthalmic lenses, such as contact lenses. The devices may be composed of a silicone hydrogel copolymer, especially where the monomeric mixture comprises a silicone-containing lens-forming monomer, a hydrophilic lens-forming monomer, and said diluent.

The extractables may be removed by immersing the devices in said diluent, and the process may further comprise, following contacting the devices with the diluent, contacting a batch of the devices with water or an aqueous solution, whereby water replaces diluent remaining in the devices.

Representative diluents include diethylene glycol monomethyl ether, diethylene glycol monoethyl ether, diethylene glycol monopropyl ether, diethylene glycol monobutyl ether, diethylene glycol monovinyl ether, and 3-methoxy-1-butanol.

According to another embodiment, this invention provides a process comprising: casting a lens-forming monomeric mixture comprising a diluent in a mold comprising a contact lens anterior mold section and a contact lens posterior mold section; removing the lens from the mold; and removing extractables from the devices by contacting the devices with an additional volume of said diluent.

### DETAILED DESCRIPTION OF VARIOUS PREFERRED EMBODIMENTS

The present invention provides a method for removing extractables from biomedical devices, especially ophthalmic biomedical devices. The term “biomedical device” means a device intended for direct contact with living tissue. The term “ophthalmic biomedical device” means a device intended for direct contact with ophthalmic tissue, including contact lenses, intraocular lenses and ophthalmic implants. In the following description, the process is discussed with particular reference to silicone hydrogel contact lenses, a preferred embodiment of this invention, but the invention may be employed for extraction of other polymeric biomedical devices.

Hydrogels comprise a hydrated, crosslinked polymeric system containing water in an equilibrium state. Accordingly, hydrogels are copolymers prepared from hydrophilic monomers. In the case of silicone hydrogels, the hydrogel copolymers are generally prepared by polymerizing a mixture containing at least one lens-forming silicone-containing monomer and at least one lens-forming hydrophilic monomer. Either the silicone-containing monomer or the hydrophilic monomer may function as a crosslinking agent (a crosslinking agent being defined as a monomer having multiple polymerizable functionalities), or alternately, a separate crosslinking agent may be employed in the initial monomer mixture from which the hydrogel copolymer is formed. (As used herein, the term “monomer” or “monomeric” and like terms denote relatively low molecular weight compounds that are polymerizable by free radical polymerization, as well as higher molecular weight compounds also referred to as “prepolymers”, “macromonomers”, and related terms.) Silicone hydrogels typically have a water content between about 10 to about 80 weight percent.

Examples of useful lens-forming hydrophilic monomers include: amides such as N,N-dimethylacrylamide and N,N-dimethylmethacrylamide; cyclic lactams such as N-vinyl-2-pyrrolidone; (meth)acrylated alcohols, such as 2-hydroxyethyl methacrylate, 2-hydroxyethyl acrylate and glyceryl methacrylate; (meth)acrylated poly(ethylene glycol)s; (meth)acrylic acids such as methacrylic acid and acrylic acid; and azlactone-containing monomers, such as 2-isopropenyl-4,4-dimethyl-2-oxazolin-5-one and 2-vinyl-4,4-dimethyl-2-oxazolin-5-one. (As used herein, the term “(meth)” denotes an optional methyl substituent. Thus, terms such as “(meth)acrylate” denotes either methacrylate or acrylate, and “(meth)acrylic acid” denotes either methacrylic acid or acrylic acid.) Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277, the disclosures of which are incorporated herein by reference. Other suitable hydrophilic monomers will be apparent to one skilled in the art.

Applicable silicone-containing monomeric materials for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Examples of applicable silicone-containing monomers include bulky polysiloxanylalkyl (meth)acrylic monomers. An example of such monofunctional, bulky polysiloxanylalkyl (meth)acrylic monomers are represented by the following Formula I:

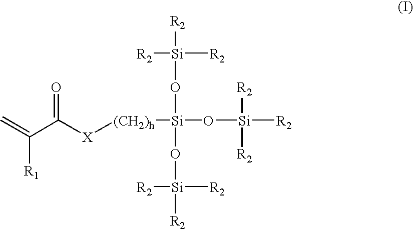

wherein:

X denotes —O— or —NR—;

each R₁ independently denotes hydrogen or methyl;

each R₂ independently denotes a lower alkyl radical, phenyl radical or a group represented by

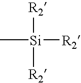

wherein each R₂′ independently denotes a lower alkyl or phenyl radical; and h is 1 to 10. One preferred bulky monomer is 3-methacryloxypropyl tris(trimethyl-siloxy)silane or tris(trimethylsiloxy)silylpropyl methacrylate, sometimes referred to as TRIS.

Another class of representative silicone-containing monomers includes silicone-containing vinyl carbonate or vinyl carbamate monomers such as: 1,3-bis[4-vinyloxycarbonyloxy)but-1-yl]tetramethyldisiloxane; 1,3-bis[4-vinyloxycarbonyloxy)but-1-yl]polydimethylsiloxane; 3-(trimethylsilyl)propyl vinyl carbonate; 3-(vinyloxycarbonylthio)propyl[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; and trimethylsilylmethyl vinyl carbonate.

An example of silicone-containing vinyl carbonate or vinyl carbamate monomers are represented by Formula II: 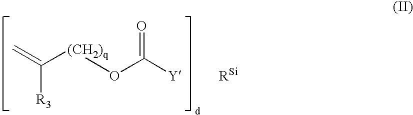
wherein:

Y′ denotes —O—, —S— or —NH—;

R^{Si} denotes a silicone-containing organic radical;

R₃ denotes hydrogen or methyl;

d is 1, 2, 3 or 4; and q is 0 or 1.

Suitable silicone-containing organic radicals R^{Si} include the following:
—(CH₂)ₙ Si[(CH₂)ₘ′CH₃]₃;
—(CH₂)ₙ′Si[OSi(CH₂)ₘ′CH₃]₃; 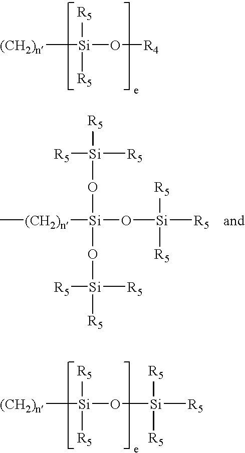
   wherein:

R₄ denotes 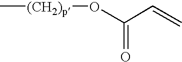
wherein p′ is 1 to 6;

R₅ denotes an alkyl radical or a fluoroalkyl radical having 1 to 6 carbon atoms;

e is 1 to 200; n′ is 1, 2, 3 or 4; and m′ is 0, 1, 2, 3, 4 or 5.

An example of a particular species within Formula II is represented by Formula III:

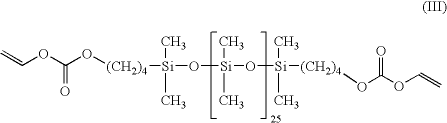

Another class of silicone-containing monomers includes polyurethane-polysiloxane macromonomers (also sometimes referred to as prepolymers), which may have hard-soft-hard blocks like traditional urethane elastomers. Examples of silicone urethane monomers are represented by Formulae IV and V:
E(*D*A*D*G)ₐ*D*A*D*E′; or (IV)
E(*D*G*D*A)ₐ*D*G*D*E′; (V)
wherein:

D denotes an alkyl diradical, an alkyl cycloalkyl diradical, a cycloalkyl diradical, an aryl diradical or an alkylaryl diradical having 6 to 30 carbon atoms;

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

* denotes a urethane or ureido linkage;

a is at least 1;

A denotes a divalent polymeric radical of Formula VI: 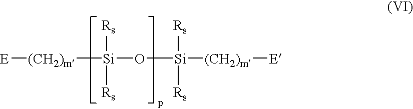
wherein:

each Rₛ independently denotes an alkyl or fluoro-substituted alkyl group having 1 to 10 carbon atoms which may contain ether linkages between carbon atoms;
m′ is at least 1; and

p is a number which provides a moiety weight of 400 to 10,000;

each of E and E′ independently denotes a polymerizable unsaturated organic radical represented by Formula VII: 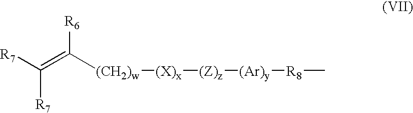
wherein:

R₆ is hydrogen or methyl;

R₇ is hydrogen, an alkyl radical having 1 to 6 carbon atoms, or a —CO—Y—R₉ radical wherein Y is —O—, —S— or —NH—;

R₈ is a divalent alkylene radical having 1 to 10 carbon atoms;

R₉ is a alkyl radical having 1 to 12 carbon atoms;

X denotes —CO— or —OCO—;

Z denotes —O— or —NH—;

Ar denotes an aromatic radical having 6 to 30 carbon atoms;

w is 0 to 6; x is 0 or 1; y is 0 or 1; and z is 0 or 1.

A more specific example of a silicone-containing urethane monomer is represented by Formula (VIII):

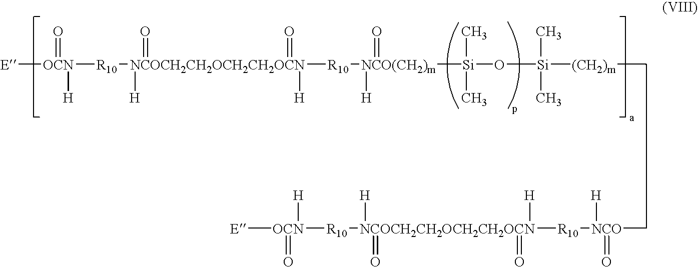

wherein m is at least 1 and is preferably 3 or 4, a is at least 1 and preferably is 1, p is a number which provides a moiety weight of 400 to 10,000 and is preferably at least 30, R₁₀ is a diradical of a diisocyanate after removal of the isocyanate group, such as the diradical of isophorone diisocyanate, and each E″ is a group represented by:

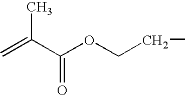

A preferred silicone hydrogel material comprises (based on the initial monomer mixture that is copolymerized to form the hydrogel copolymeric material) 5 to 50 percent, preferably 10 to 25, by weight of one or more silicone macromonomers, 5 to 75 percent, preferably 30 to 60 percent, by weight of one or more polysiloxanylalkyl (meth)acrylic monomers, and 10 to 50 percent, preferably 20 to 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 to Deichert et al. discloses additional unsaturated groups, including acryloxy or methacryloxy. Fumarate-containing materials such as those taught in U.S. Pat. Nos. 5,512,205; 5,449,729; and 5,310,779 to Lai are also useful substrates in accordance with the invention. Preferably, the silane macromonomer is a silicone-containing vinyl carbonate or vinyl carbamate or a polyurethane-polysiloxane having one or more hard-soft-hard blocks and end-capped with a hydrophilic monomer.

Specific examples of contact lens materials for which the present invention is useful are taught in U.S. Pat. No. 6,891,010 (Kunzler et al.); U.S. Pat. No. 5,908,906 (Kunzler et al.); U.S. Pat. No. 5,714,557 (Kunzler et al.); U.S. Pat. No. 5,710,302 (Kunzler et al.); U.S. Pat. No. 5,708,094 (Lai et al.); U.S. Pat. No. 5,616,757 (Bambury et al.); U.S. Pat. No. 5,610,252 (Bambury et al.); U.S. Pat. No. 5,512,205 (Lai); U.S. Pat. No. 5,449,729 (Lai); U.S. Pat. No. 5,387,662 (Kunzler et al.); U.S. Pat. No. 5,310,779 (Lai); and U.S. Pat. No. 5,260,000 (Nandu et al.), the disclosures of which are incorporated herein by reference.

Generally, the monomer mixtures may be charged to a mold, and then subjected to heat and/or light radiation, such as UV radiation, to effect curing, or free radical polymerization, of the monomer mixture in the mold. Various processes are known for curing a monomeric mixture in the production of contact lenses or other biomedical devices, including spincasting and static casting. Spincasting methods involve charging the monomer mixture to a mold, and spinning the mold in a controlled manner while exposing the monomer mixture to light. Static casting methods involve charging the monomer mixture between two mold sections forming a mold cavity providing a desired article shape, and curing the monomer mixture by exposure to heat and/or light. In the case of contact lenses, one mold section is shaped to form the anterior lens surface and the other mold section is shaped to form the posterior lens surface. If desired, curing of the monomeric mixture in the mold may be followed by a machining operation in order to provide a contact lens or article having a desired final configuration. Such methods are described in U.S. Pat. Nos. 3,408,429, 3,660,545, 4,113,224, 4,197,266, 5,271,875, and 5,260,000, the disclosures of which are incorporated herein by reference. Additionally, the monomer mixtures may be cast in the shape of rods or buttons, which are then lathe cut into a desired shape, for example, into a lens-shaped article.

As mentioned, an organic diluent is included in the initial monomeric mixture. As used herein, the term “organic diluent” encompasses organic compounds that are substantially unreactive with the components in the initial mixture, and may be used to minimize incompatibility of the monomeric components in this mixture.

Representative organic diluents include diols, polyols and ethers thereof. Specific examples include: diethylene glycol monomethyl ether, diethylene glycol monoethyl ether, diethylene glycol monopropyl ether, diethylene glycol monobutyl ether, diethylene glycol monovinyl ether, 3-methoxy-1-butanol, dipropylene glycol and dipropylene glycol monomethyl ether.

Preferred are organic diluents that have a flash point greater than 40° C., a vapor pressure lower than 10 mmHg at 25° C., and/or a boiling point of at least 100° C. at 1 atm. Especially preferred organic diluents have a flash point greater than 60° C., and/or a vapor pressure lower than 1 mmHg at 25° C.

Additionally, this same organic diluent is effective in extracting undesired residual materials from the lenses after the lenses are cast. For the extraction stage, the extractable components of the polymeric contact lenses may be removed by contacting the lenses with the organic compound for a period of time sufficient to ensure substantially complete removal of the components. For example, the contact lenses may be immersed in the extracting diluent to effect removal of extractables such as unreacted monomers and oligomers from the lenses. If desired, the lenses may be immersed in fresh extracting diluent. Also, if desired, extraction may be carried out in the receptacles of a contact lens blister package.

If desired, the extracting diluent may be heated, for example, to at least 40° C., or preferably to at least 50° C., most preferably to at least 60° C. Using heated diluent extractant may be desired to improve extraction efficiency, in removing more extractables in a shorter period of time. By employing an extracting diluent with a relatively high flash point and low vapor pressure, higher extraction temperatures may be used without risk of flammability.

Generally, the lenses will be rinsed with or soaked in water or aqueous solution following extraction with the extracting diluent.

Properties of various organic compounds are listed below.

| | Flash Point | Vapor Pressure |
|---|---|---|
| Compound | (° C.) | (mmHg@25° C.) |
| Isopropanol | 11 | 20.48 |
| Dipropylene glycol | 137 | 0.01 |
| Dipropylene glycol monomethyl ether | 74 | — |
| Diethylene glycol monobutyl ether | 100 | 0.02 |
| Diethylene glycol monopropyl ether | — | 0.06 |
| Diethylene glycol monoethyl ether | 96 | 0.14 |
| Diethylene glycol monomethyl ether | 83 | 0.17 |
| Diethylene glycol monovinyl ether | 82 | 0.06 |
| Hexylene glycol | 93 | 0.04 |
| 2-methyl-butanol | 43 | 16.57 |
| 3-methyl-butanol | 45 | 2.94 |
| 3-pentanol | 40 | — |
| 4-methyl-2-pentanol | 40 | — |
| 2-methoxy-ethanol | 46 | 8.63 |
| 3-methoxy-1-butanol | 46 | 1.07 |

The following examples illustrate various preferred embodiments of this invention. The following abbreviations are used in the illustrative examples.
ID2S4H—a polyurethane-based prepolymer endcapped with 2-methacryloxyethyl (derived from isophorone diisocyanate, diethylene glycol, a polydimethylsiloxanediol, and 2-hydroxyethyl methacrylate according to U.S. Pat. No. 5,034,561) and described more fully in Synthesis A below.
TRIS—3-methacryloxypropyl tris(trimethylsiloxy)silane
DMA—N,N-dimethylacrylamide
NVP—N-vinyl pyrrolidone
HemaVC—methacryloxyethyl vinyl carbonate
Hema—2-hydroxyethylmethacrylate
IMVT—1,4-bis(4-(2-methacryloxyethyl)phenylamino)anthraquinone (described in U.S. Pat. No. 4,997,897), a blue visibility-tinting agent
UV-Agent—2-(2′hydroxy-5′-methacrylxypropylphenyl)-5-chloro-2H-benzotriazole
Initiator—Vazo 64 thermal initiator
DEGMBE—diethylene glycol monobutyl ether
3MIB—3-methoxy-1-butanol
   Synthesis A—Preparation of a Polydimethylsiloxane-Based Polyurethane Polymer (ID2S4H)

A dry 3-neck, 1000 mL round bottom flask was connected to a nitrogen inlet tube and a reflux condenser linked. Then, isophorone (16.916 g, 0.0761 mole), diethylene glycol (4.038 g, 0.0380 mole), dibutyl tin dilaurate (0.383 g) and 140 mL of methylene chloride were added into the flask all at once and the contents were refluxed. After 16 hours, the amount of isocyanate was determined and decreased to 47.0% by titration. Then α,ω-bis(4-hydroxybutyl)polydimethylsiloxane (102.56 g, 0.02536 mole) was added into the flask. Refluxing was continued for 33 hours, and the amount of isocyanate was decreased to 14.1% of the original by titration. The contents were then cooled to ambient temperature. 2-Hydroxyethyl methacrylate (2.2928 g) and 1,1′-bi-2-phenol (0.0129 g) were then added and the contents were stirred at ambient until isocyanate peak at 2267 cm⁻¹ disappeared from IR spectrum of the product. The solvent was then stripped under reduced pressure to yield the product.

### EXAMPLE 1A

### Lens Casting

A monomer mixture was prepared from the components listed in Table 1. The amounts in Table 1 are parts by weight unless otherwise noted. The monomer mixture was placed between anterior and posterior contact lens molds, and thermally cured in a nitrogen-filled oven at 110° C. Following curing, the posterior mold sections were removed, and the contact lenses were released from the anterior mold sections.

TABLE 1

| Component | Parts by Weight |
|---|---|
| ID2S4H | 11 |
| TRIS | 35 |
| DMA | 11 |
| NVP | 40 |
| HemaVC | 0.5 |
| Hema | 5 |
| DEGMBE | 3 |
| IMVT | 150 ppm |
| UV-Agent | 0.5 |
| Initiator | 0.5 |

### EXAMPLE 1B

### Lens Extraction

The contact lenses were weighed, and then submersed into 1.2 mL of the solvents listed in Table 2. After the noted period of extraction, the lenses were removed from the solvent and placed in 2 mL deionized water for 30 minutes. The lenses were removed from the water, dried overnight in a vacuum oven at 80° C., and then weighed again. The percentage of weight loss is recorded as percent extractables. For each entry in Table 2, batches of six lenses were tested collectively. The first entry in Table 1 served as a control since extraction in isopropyl alcohol (IPA) for sixteen hours should approach removal of all extractables.

TABLE 2

| Solvent | Extraction Time | % Extractables |
|---|---|---|
| IPA | 16 hours | 5.34 |
| IPA | 60 minutes | 5.05 |
| IPA/Water (50/50) | 60 minutes | 2.48 |
| Water | 60 minutes | 2.46 |
| DEGMBE | 60 minutes | 4.2 |
| DEGMBE/Water (50/50) | 60 minutes | 2.22 |

As seen in Table 2, diethylene glycol monobutyl ether was effective for extracting silicone hydrogel contact lenses cast from monomeric mixtures including this same organic compound as a diluent.

### EXAMPLE 2A

### Lens Casting

A monomer mixture was prepared from the components listed in Table 3. The amounts in Table 3 are parts by weight unless otherwise noted. The monomer mixture was placed between anterior and posterior contact lens molds, and thermally cured in a nitrogen-filled oven at 110° C. Following curing, the posterior mold sections were removed, and the contact lenses were released from the anterior mold sections.

TABLE 3

| Component | Parts by Weight |
|---|---|
| ID2S4H | 11 |
| TRIS | 35 |
| DMA | 11 |
| NVP | 40 |
| HemaVC | 0.5 |
| Hema | 5 |
| 3M1B | 3 |
| IMVT | 150 ppm |
| UV-Agent | 0.5 |
| Initiator | 0.5 |

### EXAMPLE 2B

### Lens Extraction

The contact lenses were weighed, and then submersed into 1.2 mL of the solvents listed in Table 4. After the noted period of extraction, the lenses were removed from the solvent and placed in 2 mL deionized water for 10 minutes; the water was decanted and replaced with fresh deionized water for 10 more minutes. The lenses were removed from the water, dried overnight in a vacuum oven at 80° C., and then weighed again. The percentage of weight loss is recorded as percent extractables. For each entry in Table 4, batches of six lenses were tested collectively. The first entry in Table 1 served as a control.

TABLE 4

| Solvent | Extraction Time | % Extractables |
|---|---|---|
| IPA | 90 minutes | 4.55 |
| 3M1B | 10 minutes | 4.27 |

As seen in Table 4, 3-methoxy-1-butanol was effective for extracting silicone hydrogel contact lenses cast from monomeric mixtures including this same organic compound as a diluent, even with an extraction time as short as 10 minutes.

### EXAMPLE 2C

### Lens Extraction

Lenses from Example 2A were placed into individual contact lens blister package receptacles. Then, 0.6 mL of 3-methoxy-1-butanol was added to the package receptacle. After 10 minutes, 3-methoxy-1-butanol was removed and replaced with 0.6 mL of deionized water. After 1 minute, the water was removed and fresh water was added. After another minute, the water was removed and replaced with fresh water. After 7 minutes, this water was removed. The lenses were removed, dried, and weighed. Percent extractables was determined as 4.11%.

### EXAMPLE 2D

### Lens Extraction

Lenses from Example 2A were placed into individual contact lens blister package receptacles. Then, 0.6 mL of 3-methoxy-1-butanol preheated to 60° C. was added to the package receptacles. After 2 minutes solvent was removed, and fresh same solvent at 60° C. was added. After 1.5 minutes. the solvent was removed, then fresh same solvent at 60° C. was added, and then the solvent was after 1.5 minutes. The lenses were washed with 0.6 mL of deionized water heated to 60° C., for 2, 1.5 and 1.5 minute successive cycles. The level of extractables was 5.25%. This example indicates extractables can be removed more efficiently and/or faster if the solvent is used at higher temperatures.

Having thus described the preferred embodiment of the invention, those skilled in the art will appreciate that various modifications, additions, and changes may be made thereto without departing from the spirit and scope of the invention, as set forth in the following claims.

We claim:

1. A process for producing polymeric biomedical devices, comprising:
casting a monomeric mixture comprising a diluent; and
subsequently removing extractables from the devices by contacting the devices with said diluent.

2. The process of claim 1, wherein said diluent has a flash point greater than 40° C.

3. The process of claim 1, wherein said diluent has a vapor pressure lower than 10 mmHg at 25° C.

4. The process of claim 1, wherein said diluent has a boiling point of at least 100° C. at 1 atm.

5. The process of claim 1, wherein said diluent has a flash point greater than 40° C., a vapor pressure lower than 10 mmHg at 25° C., and a boiling point of at least 1001C at 1 atm.

6. The process of claim 1, wherein said devices are ophthalmic biomedical devices.

7. The process of claim 6, wherein said devices are ophthalmic lenses.

8. The process of claim 7, wherein said devices are contact lenses.

9. The process of claim 8, wherein the contact lenses are composed of a silicone hydrogel copolymer.

10. The process of claim 9, wherein the monomeric mixture comprises a silicone-containing lens-forming monomer, a hydrophilic lens-forming monomer, and said diluent.

11. The process of claim 1, wherein the devices are composed of a silicone hydrogel copolymer.

12. The process of claim 1, wherein extractables are removed from the devices by immersing the devices in said diluent.

13. The process of claim 1, further comprising, following contacting the devices with said diluent, contacting said batch of the devices with water or an aqueous solution, whereby water replaces diluent remaining in the devices.

14. The process of claim 1, wherein said diluent is a diol, a polyol, or an ether thereof.

15. The process of claim 14, wherein said diluent is diethylene glycol or an ether thereof.

16. The process of claim 14, wherein said diluent includes at least one member selected from the group consisting of diethylene glycol monomethyl ether, diethylene glycol monoethyl ether, diethylene glycol monopropyl ether, diethylene glycol monobutyl ether, diethylene glycol monovinyl ether, and 3-methoxy-1-butanol.

17. The process of claim 1, wherein during extraction, the devices are contacted with said diluent having a temperature of at least 40° C.

18. The process of claim 17, wherein the devices are contacted with said diluent having a temperature of at least 50° C.

19. The process of claim 18, wherein the devices are contacted with said diluent having a temperature of at least 60° C.

20. The process of claim 1, comprising:
casting a lens-forming monomeric mixture comprising a diluent in a mold comprising a contact lens anterior mold section and a contact lens posterior mold section;
removing the lens from the mold; and
removing extractables from the devices by contacting the devices with an additional volume of said diluent.
